(19) United States
(12) Patent Application Publication
(10) Pub. No.: US 2010/0015347 A1
(43) Pub. Date: Jan. 21, 2010

(54) DEVICE AND METHOD FOR HOT DIP COATING A METAL STRIP

(76) Inventor: Peter de Kock, Oberhausen (DE)

Correspondence Address: FRIEDRICH KUEFFNER, 317 MADISON AVENUE, SUITE 910, NEW YORK, NY, 10017, US

(21) Appl. No.: 12/449,599

(22) PCT Filed: Feb. 5, 2008
(86) PCT No.: PCT/EP2008/000878

§ 371 Date: Sep. 8, 2009

(30) Foreign Application Priority Data
Feb. 16, 2007 (DE) 10 2007 008 308.6
Aug. 3, 2007 (DE) 10 2007 036 743.2
Aug. 24, 2007 (DE) 10 2007 040075.8
Nov. 29, 2007 (DE) 10 2007 057 480.2

(51) Int. Cl. B05D 1/18; B05C 3/02

(52) U.S. Cl. 427/433; 427/431; 118/428

(57) ABSTRACT

2.1 The present invention pertains to a hot-dip coating device 100 for coating a metal strip with a molten metal 200. The metal strip is deflected in the molten metal 200 with the aid of a roll 120. The roll is rotatably supported in a support arm 105 by means of a bearing 144. The bearing is installed in a bearing chamber 142. In order to seal the bearing chamber 142 against an undesirable admission of the molten metal 200, a lock is arranged between the bearing chamber 142 and a roll passage 136 toward the molten metal 200 and acted upon with a gaseous medium under a gas pressure in order to seal the lock chamber 132 relative to the molten metal 200.

2.2 In order to lower the maintenance expenditures for the lock, the invention proposes to realize the lock chamber 132 in the form of a diving bell with a channel-shaped outlet 134 that is open relative to the surrounding molten metal 200.

The invention pertains to a device and a method for hot-dip coating a metal strip.

A device of this type is basically known, for example, from DE 10 2004 030 207 A1. The hot-dip coating device disclosed in this publication comprises a receptacle for the molten metal, through which the metal strip is conveyed. During the passage through the molten metal, the metal strip is deflected in the molten metal and stabilized with the aid of a roll that features a roll body and a roll neck. The roll or the roll neck is respectively supported by rolling bearings. In order to ensure their operatability, the rolling bearings need to be protected from the aggressive molten metal. In this case, the roll passage toward the molten metal needs to be closed with an effective seal in order to prevent the admission of molten metal into the rolling bearing. In the aforementioned Offenlegungsschrift, the seal is realized with the aid of a lock that surrounds the roll neck with a lock chamber that is closed or sealed relative to the molten metal—except for a leak at the roll passage, i.e., at the transition to the roll neck. In order to prevent the admission of molten metal through the roll passage, the lock chamber is acted upon with a gaseous medium with a gas pressure. The lock features a collection container for collecting leakage losses in the form of small quantities of molten metal that were admitted into the lock chamber despite the gas pressure. This collection container needs to be periodically emptied, wherein this requires that the collection container is initially uninstalled and subsequently reinstalled such that the operation of this lock is associated with increased maintenance expenditures.

Based on this state of the art, the invention aims to additionally develop a known device and a known method for hot-dip coating a metal strip in such a way that the maintenance expenditure, in particular, for the lock is reduced.

This objective is attained with the characteristics of device claim 1. According to this claim, the inventive hot-dip coating device is characterized in that the lock with the lock chamber is immersed in the molten metal, and in that the lock chamber is realized in the form of a diving bell with a channel-shaped outlet that immerses in the molten metal and is open relative thereto.

In the claimed design of the lock chamber in the form of a diving bell, slight leakage losses are consciously accepted. They are harmless and do not increase the maintenance expenditures because the small quantities of molten metal that are admitted into the interior of the lock chamber through the roll passage against the gas pressure are directly returned to the molten bath via the channel-shaped outlet. This means that the collection of leakage losses in a separate collection container and the associated maintenance expenditures known from the state of the art can be eliminated in the inventive design of the lock.

For reasons of simplicity, the present description does not distinguish between a drive shaft that may be coupled to the roll neck and the roll neck itself; consequently, the term roll neck may also refer to a drive shaft, particularly if the drive shaft rather than the roll neck is surrounded by the bearing and rotationally supported in the bearing in one concrete embodiment.

According to a first embodiment of the invention, the bearing chamber with the bearing for the roll neck is realized such that it communicates with the lock chamber with respect to the gaseous medium. This provides the advantage that the gas pressure is also present in the bearing chamber and the molten metal is prevented from reaching the bearing in this fashion.

The claimed lock in the form of a diving bell may be arranged between the bearing chamber and the roll body by itself or together with other locks that may, e.g., be open or closed relative to the molten metal. This parallel arrangement of locks collectively acts as a redundant cascade-shaped seal system for sealing the bearing chamber relative to the molten metal situated on the other side of the seal system, i.e., in the region of the roll body. Leaks in the individual locks, particularly locks that are—as described above—realized in the form of a diving bell, are consciously accepted and do not contradict the primary objective, i.e., maintaining the bearing chamber free of molten metal.

The individual locks and, if applicable, the bearing chamber basically could be respectively acted upon separately and thusly sealed relative to the molten metal. According to the invention, however, it is preferred that the bearing chamber and the different lock chambers are realized such that they communicate with respect to the gaseous medium and allow the gaseous mediums to flow in at least one direction. This is advantageously realized, in particular, with a lip seal in the transition area between two adjacent chambers, wherein the lip seal allows the gaseous medium to flow in one direction and acts as a check valve for the gaseous medium, as well as a lock for possibly leaking molten metal, in the other direction.

The roll passage in the transition area between the lock chamber and the liquid molten metal represents a significant leak of the hot-dip coating device, namely for gaseous medium that escapes from the lock chamber into the molten metal and for molten metal being admitted into the lock chamber. The inventive return of the undesirably admitted molten metal into the molten bath was already mentioned above.

A gas separating element may be advantageously provided outside the lock adjacent to the roll passage in order to collect the gaseous medium that escapes from the lock chamber into the molten metal. This collected medium can then be advantageously returned to the bearing chamber or the lock chambers via a gas circuit. However, it would be alternatively possible to release the collected medium into the ambient air.

Although the leaks in the region of the roll passage are basically accepted, they are still undesirable. The tightness in the region of the roll passage can be significantly improved by providing a rubbing seal at this location which is pressed against the roll body or against a projection of the roll neck parallel to the roll axis due to the pressure differential between the gas pressure in the lock chamber and the pressure in the bath of molten metal. If applicable, the gas circulation system for the above-described return of the escaped gas can be advantageously eliminated in this case. Alternatively or additionally to the rubbing seal, an inductive seal may also be provided in the region of the roll passage. The inductive seal can also be used as a ring seal relative to the roll neck.

The gas pressure in the lock chambers and in the bearing chamber is advantageously monitored with the aid of a pressure control circuit and preferably maintained constant.

It is advantageous that a drive for turning the roll neck and therefore the entire roll is also integrated into the bearing chamber. The drive may be realized, for example, in the form of an electric motor or a specially designed compressed air motor. As an alternative to the arrangement of the drive within the bearing chamber, said drive may also be arranged externally, i.e., outside the molten metal, wherein the roll neck and the roll are set in rotation by means of a mechanical connection such as, for example, a thrust crank drive.

The above-described objective is furthermore attained with a claimed method for operating a hot-dip coating device. The advantages associated with this method correspond to the advantages described above with reference to the hot-dip coating device.

Five figures are enclosed with the description, wherein

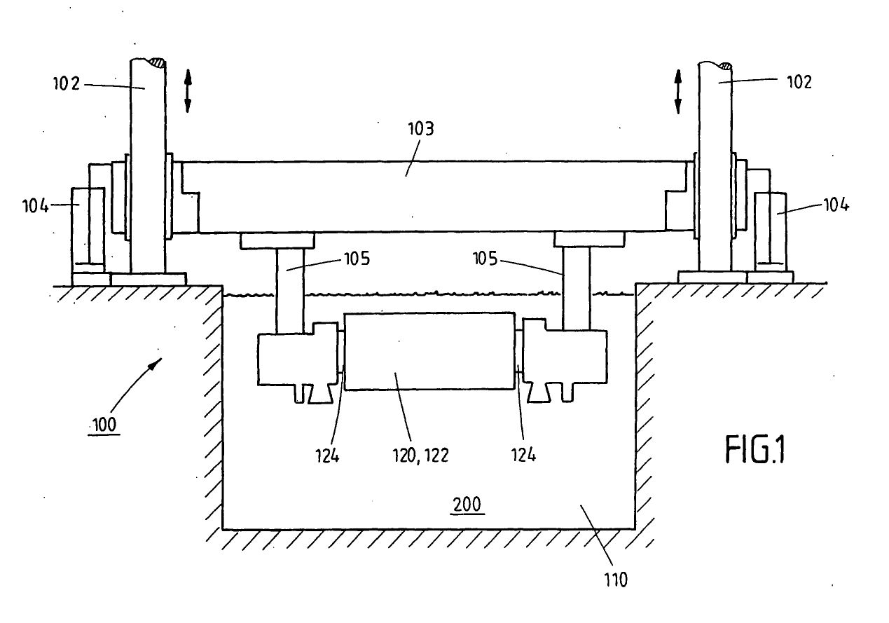

FIG. 1 shows a hot-dip coating device as a whole;

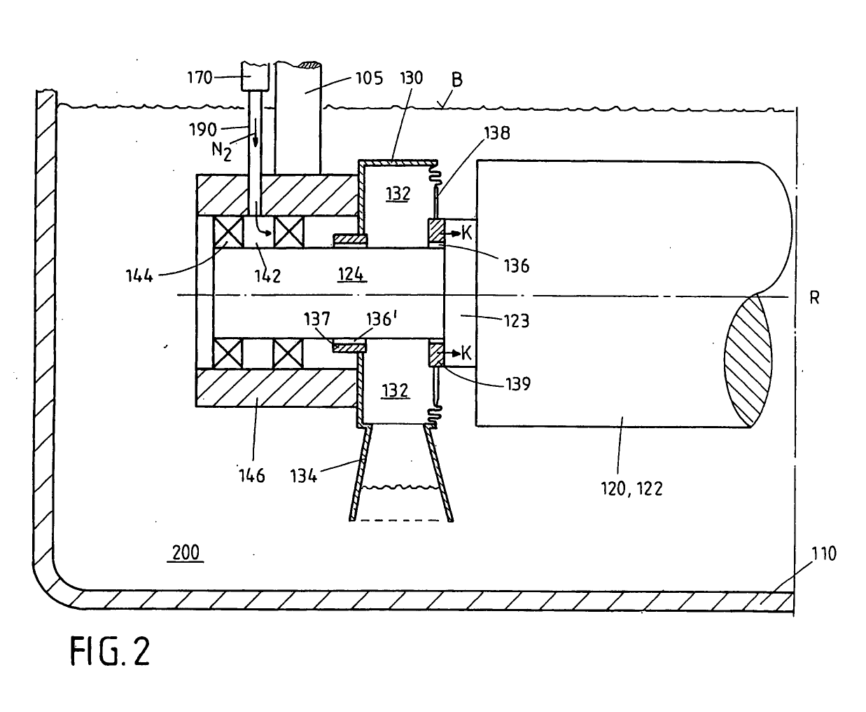

FIG. 2 shows the support and the seal of the roll according to a first embodiment of the invention;

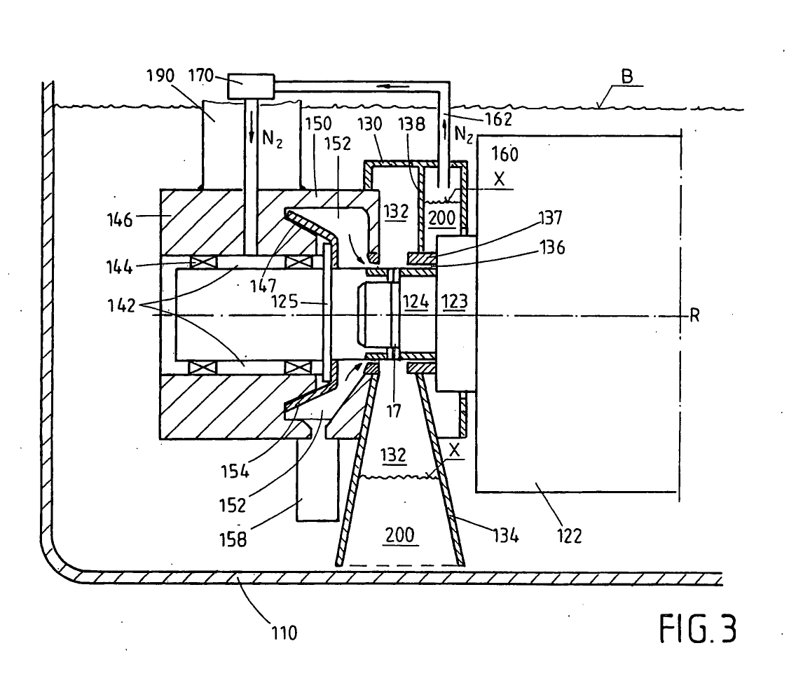

FIG. 3 shows the support and the seal of the roll according to a second embodiment of the invention;

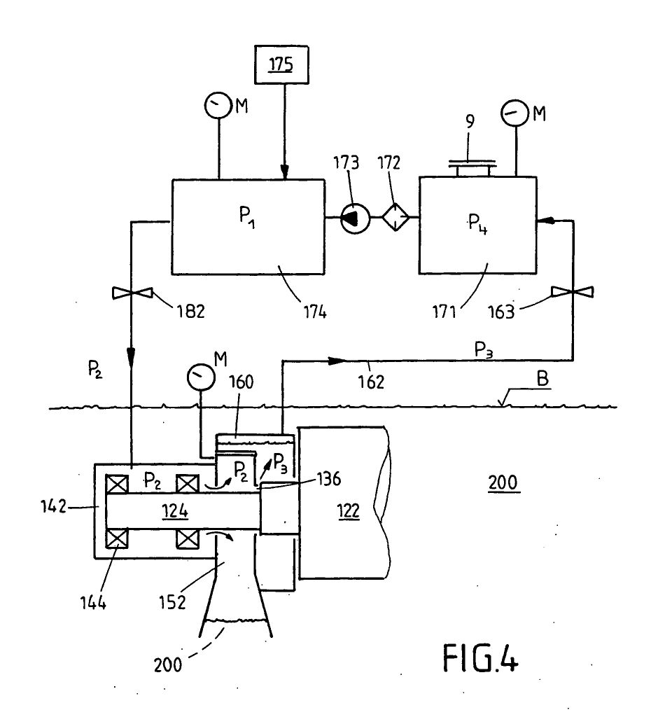

FIG. 4 shows a gas circuit for the hot-dip coating device, and

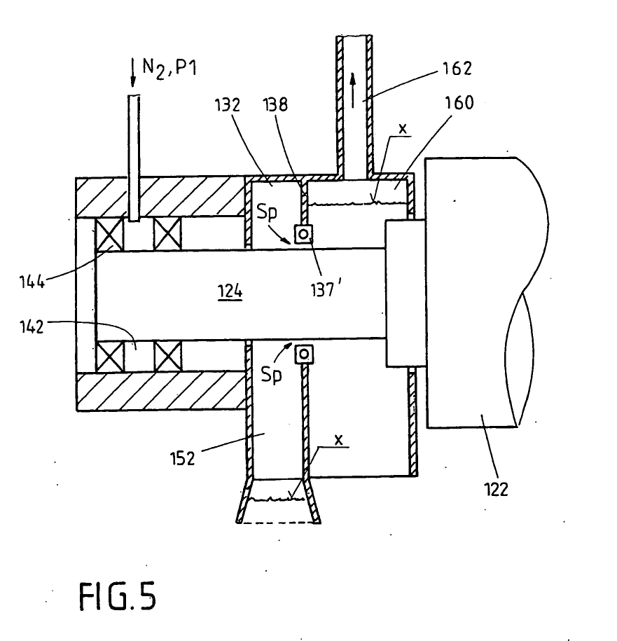

FIG. 5 shows the support and the seal of the roll according to a third embodiment of the invention.

Embodiments of the invention are described in greater detail below with reference to the aforementioned figures. Identical technical elements are respectively identified by the same reference symbols in all figures.

FIG. 1 shows a hot-dip coating device 100 for coating a (not-shown) metal strip. The device comprises two vertical posts 102 that are arranged to both sides of a receptacle 110 filled with a molten metal 200. A crosshead 103 is vertically displaced along these posts with the aid of vertical drives 104. The crosshead 103 contains two suspended support arms 105, between which a roll 120 is rotationally supported. After its immersion into the molten metal, the metal strip is deflected around the roll 120 or, more precisely, around its roll body 122 before it upwardly emerges from the molten metal again. The roll with its bearing arrangement on the support arms 105 can be lowered into the molten metal 200 or lifted out of the molten metal for maintenance purposes or at standstill times with the aid of the vertically displaceable crosshead 103.

FIG. 2 shows a first embodiment of the inventive hot-dip coating device in the form of a detail of FIG. 1. This figure shows the receptacle 110 with the molten metal 200 contained therein, wherein the bath level of the molten metal is identified by the reference symbol B. The roll 120 suspended on the support arm 105 is immersed in the molten metal 200 together with its bearing arrangement. This figure specifically shows the roll neck 124 that is supported in the support arm 105, for example, by means of a rolling bearing 144. The vicinity of the rolling bearing is referred to as the bearing chamber 142 below. This figure furthermore shows a gas line 190 for supplying the bearing chamber 142 with a gaseous medium such as, for example, nitrogen. The gas line 190 is preferably coiled in the shape of a spiral shortly before it leads into the bearing chamber 142. This spiral-shaped coil represents an extended path for the supplied gaseous medium N₂ before it is introduced into the bearing chamber 142; when the spiral-shaped coil is immersed in the hot molten metal 200, the gaseous medium flowing through the spiral-shaped coil is already pre-heated to the temperature of the molten metal before it is introduced into the bearing chamber 142.

An inventive lock 130 is arranged between the bearing chamber 142 and the roll body 122 and surrounds the roll neck 124 with a lock chamber 132. The lock 130 is immersed in the molten metal 200 analogous to the bearing housing 146 and the roll body 122 and therefore surrounded by the molten metal. According to the invention, the lock 130 and its lock chamber 132 are realized in the form of a diving bell with a channel-shaped outlet 134 that is also immersed in the molten metal 200 during the operation of the hot-dip coating device; the outlet 134 is open relative to the molten metal.

The lock 130 is arranged between the bearing chamber 142 and the roll body 122. In the transition area between the bearing chamber 142 and the lock chamber 132, a partition wall ends on the side of the neck with a bushing 137 that encloses the neck 124 of the roll 120. An annular gap 136 remains between the inside diameter of the bushing 137 and the outside diameter of the neck in order to realize a controlled passage of the gaseous medium N₂ between the bearing chamber 142 and the lock chamber 132.

The opposite wall 138 of the lock chamber assigned to the roll body 122 is preferably realized flexibly or elastically, for example, in the form of a membrane. On the side of the neck, the wall 138 ends with a ring seal 139. However, this ring seal 139 is not hundred per cent tight on the side of the neck such that a certain leak relative to the neck 124 remains. This leak may represent a leak that enables the gaseous medium N₂ to escape into the surrounding molten metal 200 from the lock chamber 132, as well as a leak that enables the molten metal 200 to be admitted into the lock chamber 132 at the roll passage 136.

In order to reduce this leak, the ring seal 139 preferably is, according to the invention, realized in the form of a rubbing seal that rubs on the roll body 122 or a projection 123 of the roll neck 124.

The seal of the bearing 144 shown in FIG. 2 for preventing a possible undesirable admission of molten metal 200 functions as described below:

The gaseous medium, preferably nitrogen, is supplied into the bearing chamber 142 through the gas line 190. The gaseous medium flows around the bearing 144 inside the bearing chamber before it flows into the lock chamber 132 through the annular gap 136′.

The bearing chamber 142 and the lock chamber 132 are realized such that they communicate with respect to the gaseous medium via the annular gap 136. Consequently, the same gas pressure is adjusted in the bearing chamber and the lock chamber. The gas pressure is chosen so high that the admission of molten metal 200 into the interior of the lock chamber 132 through the open channel-shaped outlet 134 of the lock 130 is effectively prevented. This pressure simultaneously acts against the flexible outer wall 138 of the lock chamber 132. On its outer side, this outer wall 138 is subjected to the pressure exerted by the molten metal 200. Consequently, the rubbing ring seal 139 is pressed against the projection 123 or the roll body 122 parallel to the axial direction R of the roll with the differential pressure between the gas pressure in the interior of the lock chamber 132 and the pressure exerted upon the outer wall 138 by the molten metal 200, namely with a force K. For this purpose, the gas pressure in the interior of the lock chamber 132 needs to be chosen suitably high in relation to the pressure exerted by the molten metal. In comparison with a simple seal relative to the surface of the neck, the realization of the ring seal 139 in the form of a rubbing seal results in a significant improvement of its sealing effect. All in all, the quantity of molten metal admitted through the roll passage 136 can be significantly reduced in this fashion. The admitted quantity of molten metal is accepted. It drips off the roll neck 124 and into the channel-shaped outlet 134 in the immediate vicinity of the lock chamber 132 and is immediately returned to the molten bath in the receptacle 110 in this fashion. This makes it possible to very effectively protect the bearing chamber 142 and, in particular, the bearing 144 from the aggressive molten metal 200 without maintenance expenditures.

FIG. 3 shows a second embodiment of the present invention. This embodiment essentially can be distinguished from the first embodiment illustrated in FIG. 2 in that another lock 150 with another lock chamber 152 surrounding the roll neck 124 is arranged between the bearing chamber and the lock according to FIG. 2. The second lock additionally improves the protection of the bearing chamber against the admission of molten metal; in combination with the lock 130 in the form of a diving bell, the additional lock 150 represents a cascade-shaped seal. The additional lock chamber 152 is preferably realized such that it communicates with the bearing chamber 142 and the lock chamber 132 with respect to the gaseous medium. This communication is restricted to one flow direction of the gaseous medium, namely from the bearing chamber 142 into the additional lock chamber 152, by means of a lip seal 152. The lip seal 154 is securely fixed on the roll neck 124 on a flange 125. During the rotation of the roll neck and the roll, the lip seal 154 also rotates in the embodiment illustrated in FIG. 3 while it slides on a projection 147 of the bearing housing 143. A partition wall between the additional lock chamber 152 and the lock chamber 132 is sealed toward the roll neck 124 by means of a ring seal although this seal is not hundred per cent tight due to the rotational movement of the neck and allows, in particular, a restricted flow of the gaseous medium from the additional lock chamber 152 into the lock chamber 132.

In contrast to the lock 130, the additional lock 150 is sealed off against the admission of molten metal 200 in the transition area between the additional lock chamber 152 and the lock chamber 132—except for the leak at the seal on the side of the neck. The additional lock 150, in particular, is not realized in the form of a diving bell and therefore not provided with an outlet that is open toward the molten metal 200. Instead, it features a collection container 158 that is open toward the additional lock chamber and makes it possible to collect molten metal that was able to pass through the lock 130. The additional creeping of the molten metal from the additional lock chamber 152 into the bearing chamber 142 on the surface of the roll neck 124 is stopped no later than at the aforementioned flange 125, on which the lip seal 154 is fixed. In this respect, an additional protection against the admission of molten metal 200 into the bearing chamber 142 is realized with the additional lock 150 in cooperation with the lip seal 154.

If a shaft such as, for example, a drive shaft is axially coupled to the roll neck 124, it is recommended to arrange the interface, for example, in the form of a joint 17 in the region of the lock chamber 132 or, even better, in the region of the additional lock chamber 152 because this location is situated even farther from the passage 136. The sensitive joint can be prevented from becoming agglutinated or contaminated due to the admission of liquid metal 200 in this fashion.

A gas separating element 160 is provided between the lock 130 and the roll body 122 and also immersed in the molten metal 200. The gas separating element serves for collecting small quantities of the gaseous medium that can escape from the lock chamber 132 into the molten metal 200 past the rubbing ring seal 139. The gas separating element 160 is realized in a bell-shaped fashion and features a riser 162, through which the gaseous medium can be bled off the molten metal. From the riser 162, the gaseous medium can either be discharged into the ambient air or collected in a (not-shown) receptacle in order to be returned into the bearing chamber 142 by the supply means 170. The latter-mentioned alternative represents a closed circuit for the gaseous medium and therefore is particularly harmless to the environment. According to the invention, the passage between the wall of the gas separating element 160 and the surface of the projection 123 of the roll neck 124 or of the roll neck 124 itself is respectively realized such that no gaseous medium can be admitted into the molten metal 200 outside the gas separating element.

The gas pressure in the bearing chamber 142, the additional lock chamber 152 and the lock chamber 132 is preferably monitored with the aid of a manometer M and regulated, preferably maintained constant, with the aid of a (not-shown) control circuit. In this control circuit, the means 170 for supplying the gaseous medium to the bearing chamber 142 acts as a pump or as an actuator.

The circuit for the gaseous medium is illustrated in detail in FIG. 4. The gaseous medium N₂ is stored in a tank 174 with a gas pressure P1. The pressure of the gaseous medium is adjusted to an operating pressure, particularly to the pressure required in the bearing chamber 142, by means of a throttle 182. The gaseous medium then flows from the bearing chamber 142 into the lock chamber 152 via the additional lock chamber 132 possibly arranged therebetween and subsequently into the gas separating element 160 through the roll passage 136. The gas pressure P3 at this location may differ from the gas pressure in the lock chamber 152 and is adjusted by means of a second throttle 163. The riser 162 leads into a receptacle 171, in which the returning contaminated gaseous medium is collected. It is necessary to adjust the gas pressure P3 in the gas separating element 160 higher than a gas pressure P4 in the receptacle 171 in the form of an individual intermediate pressure so as to ensure that the gas ascends into the receptacle 171 within the gas separating element 160 due to the difference of pressure.

The receptacle 171 and the tank 174 may be simultaneously utilized as collection containers by several gas circuits in the form of common elements. In this case, it is necessary to respectively adjust a higher pressure P3 than in the receptacle 171 in the gas separating elements that are respectively assigned to the bearing arrangements of other rolls and may also be arranged in the molten metal at different depths. The receptacle 171 features a manhole 9 for cleaning purposes. The gas circuit is closed by a connection between the receptacle 171 and the tank 174, wherein this connection contains a filter 172 for cleaning the gaseous medium to be returned and a pump 173 for pumping the gaseous mediums into the tank 174 and into the entire circuit. Possible gas losses in the gas circuit are replenished from a gas network, particularly a nitrogen network, of the hot-dip coating device 100 or a different supply tank 175. The pressure in the receptacle 171 and the pressure in the tank 174 can be monitored with the aid of a manometer M.

FIG. 5 discloses a third embodiment of the inventive hot-dip coating device. The lock chamber 132 and the gas separating element 160 are arranged between the bearing chamber 142 with the bearings 144 and the roll body 122. The lock chamber 132 is realized in the form of a diving bell. An inductive seal 137′ is arranged on the end of the partition wall 138 between the lock chamber 132 and the gas separating element 160 on the side of the neck. This inductive seal essentially consists of a coil with current-carrying conductors that are coiled coaxial to the roll neck 124. The magnetic field induced by this current-carrying conductor prevents the admission of molten metal 200 into the lock chamber 132 from the gas separating element 160. The reference symbol x in FIG. 5 identifies the bath level of the molten metal. The gap Sp between the inductive seal and the roll neck 124 limits the flow of gas from the lock chamber 132 into the gas separating element 160.

1. A hot-dip coating device (100) for coating a metal strip with a molten metal (200), with
a receptacle (110) for the molten metal (200);
a roll (120) that is immersed in the molten metal and serves for deflecting or stabilizing the metal strip during its passage through the molten metal, wherein the roll features a roll body (122) and a roll neck (124);
a lock (130) that surrounds the roll neck (124) with a lock chamber (132); and with
means (170) for supplying a gaseous medium (N₂) with a gas pressure into the lock chamber (132) in order to seal the lock chamber relative to the molten metal (200), wherein the lock with the lock chamber (132) is immersed in the molten metal (200); and in
that the lock chamber (132) is realized in the form of a diving bell with a channel-shaped outlet (134) that immerses into the molten metal (200) and is open relative thereto.

2. The hot-dip coating device (100) according to claim 1, wherein a bearing chamber (142) with a bearing (144) on the roll neck (124) in order to support the roll neck in a support arm (105), wherein the bearing chamber (142) is realized such that it communicates with the lock chamber (132) with respect to the gaseous medium (N₂).

3. The hot-dip coating device according to claim 2, wherein a driving device is arranged in the bearing chamber (142) in order to turn the roll neck and therefore the roll body.

4. The hot-dip coating device according to claim 2, wherein the bearing chamber coincides with the lock chamber or is realized separately thereof, wherein the lock chamber (132) is arranged between the bearing chamber (142) and the roll body (122) in the latter instance.

5. The hot-dip coating device (100) according to claim 1, wherein at least one additional lock (150) with an additional lock chamber (152) that surrounds the roll neck (124) between the bearing chamber and the roll body.

6. The hot-dip coating device (100) according to claim 5, wherein the additional lock chamber (152) is realized such that it communicates with the lock chamber (132) or with the bearing chamber (142) or with the lock chamber and the bearing chamber with respect to the gaseous medium (N₂).

7. The hot-dip coating device (100) according to claim 2, wherein a lip seal (154) is arranged between two adjacent chambers (132, 142, 152) and allows the gaseous medium to pass in at least one flow direction while acting as a check valve, particularly for the molten metal, in the opposite direction or that an annular gap (136) is provided between the outside diameter of the roll neck and the edge of an opening in a common wall of the two chambers in order to realize a gas passage.

8. The hot-dip coating device (100) according to claim 7, wherein the additional lock chamber (152) is closed relative to the molten metal (200) and for the gaseous medium (N₂)—except for leaks, for example, in the form of the annular gap—and features a collection container (158) for molten metal that is possibly admitted into the additional lock chamber (152) through the leaks.

9. The hot-dip coating device (100) according to claim 5, wherein a wall (138) of the lock chamber (132) or the additional lock chamber (152) which is exposed to the molten metal (200) is realized flexibly, e.g., in the form of a membrane, and in that the edge of the opening in the wall which faces the roll neck is realized in the form of a rubbing seal (139) that is pressed against the roll body (122) or a projection (123) of the roll neck in the molten metal parallel to the roll axis due to the fact that the gas pressure in the lock chamber (132) or in the additional lock chamber (152) is higher than the ambient pressure.

10. The hot-dip coating device according to claim 1, wherein
an inductive seal for sealing a transition area between the molten metal (20a) and the lock chamber (132) or the additional lock chamber (152).

11. The hot-dip coating device (100) according to claim 1, wherein a gas separating element (160) for collecting the gaseous medium (N₂) that has escaped from one of the chambers (132, 142, 152) into the molten metal.

12. The hot-dip coating device (100) according to claim 11, wherein a gas circulation system, wherein the gaseous medium (N₂) collected by the gas separating element (160) is returned into the chambers by the supply means (170).

13. The hot-dip coating device (100) according to claim 2, wherein the means (170) for supplying the gaseous medium are arranged such that the gaseous medium (N₂) is initially introduced into the bearing chamber (142) in order to flow around the bearing (144) within the bearing chamber before it is admitted into the lock chamber (132) or the additional lock chamber (152).

14. The hot-dip coating device (100) according to claim 1, wherein a control circuit for regulating, particularly for maintaining constant, the gas pressure in the lock chamber (132) or the additional lock chamber (152) or the bearing chamber (142), wherein the gas pressure in at least one of the chambers is monitored with the aid of a manometer (M).

15. A method for operating a hot-dip coating device (100) with a roll (120) that features a roll body (122) and a roll neck (124) and with at least one lock (130) that surrounds the roll neck (124) with a lock chamber (132), comprising the following steps:
conveying a metal strip through a molten metal (200);
deflecting or stabilizing the metal strip in the molten metal with the aid of the roll (120); and
supplying a gaseous medium (N₂) with a gas pressure into the lock chamber (132) in order to seal the lock chamber relative to the molten metal (200);
wherein at least partially displacing the molten metal (200) from an open channel-shaped outlet (134) of the lock chamber (132) in the form of a diving bell which is immersed in the molten metal by means of the gas pressure in the lock chamber.

16. The method according to claim 15, wherein the gaseous medium (N₂) is initially introduced into a bearing chamber (142) in order to subsequently flow into the at least one lock chamber (132, 152).

17. The method according to claim 16, wherein the gaseous medium (N₂) escapes into the molten metal (200) from one of the lock chambers (152, 132) and is collected therein.

18. The method according to claim 17, wherein the collected gaseous medium (N₂) is returned to the bearing chamber (142) or to one of the lock chambers (132, 152).

19. The method according to claim 17, wherein a seal (139) in the transition area between the lock chamber (132) and the molten metal (200) is pressed against the roll body (122) or a projection (123) of the roll neck with a force parallel to the roll axis due to the gas pressure in the lock chamber.

20. The method according to claim 17, wherein the crosshead (103) with the immersion roll can be lifted out of and lowered into the zinc bath by means of a lifting device (102, 104) in order to ensure a uniform immersion of the downwardly open lock chambers in the zinc bath.
